(19) United States
(12) Patent Application Publication
(10) Pub. No.: US 2005/0150080 A1
(43) Pub. Date: Jul. 14, 2005

(54) Dual-directional hinge for a mobile phone

(75) Inventors: Sheng-Nan Lu, Shulin City (TW); Hsiang-Chi Chien, Shulin City (TW)

Correspondence Address: Troxell Law Office PLLC, Suite 1404, 5205 Leesburg Pike, Falls Church, VA, 22041, US

(73) Assignee: Shin Zu Shing Co., Ltd.

(21) Appl. No.: 10/754,728

(22) Filed: Jan. 12, 2004

(51) Int. Cl. E05D 3/10

(52) U.S. Cl. 16/367

(57) ABSTRACT

A dual-directional hinge is composed of a first hinge member and a second hinge member perpendicular to the first hinge. The first hinge member has a pintle received in a first tubular part. An opening is radially defined at a top side of the first tubular part. The second hinge member has a second tubular part rotatably received in the opening. Two arms are respectively formed at two diametrically opposite sides of the second tubular part. A resilient member is received in the second tubular part. An upper disk under the resilient member has a ridge formed at a bottom surface thereof. A lower disk has a channel for positioning the ridge in the channel. A shaft extends through the first hinge member, the lower disk, the upper disk, the resilient member and the second tubular part and secured in the first hinge member and the lower disk.

### BACKGROUND OF THE INVENTION

1. Field of the Invention

The present invention relates to a mobile phone, and more particularly to a dual-directional hinge for a mobile phone.

2. Description of Related Art

Current mobile phones have evolved from monochrome displays to color displays. Furthermore, some mobile phones have a built-in digital camera for taking photographs and the color display can be used as a viewfinder.

In a folding mobile phone with two parts pivotally joined together by a hinge, the display is installed in the first part, and the built-in digital camera and a key pad are installed in the second part. A lens for the digital camera is generally provided at an interior side of the second part facing the first part in a closed position.

However, the first part and the second part can only be pivoted about a horizontal axis of the hinge to open or shut the mobile phone. During taking a photograph by using the mobile phone, the lens at the interior side of the second part must be faced towards the object to be photographed, whereby the display is also faced towards the object and can not be seen by a user.

Therefore, the invention provides a dual-directional hinge to mitigate or obviate the aforementioned problems.

### 0SUMMARY OF THE INVENTION

The main objective of the present invention is to provide a dual-directional hinge for a mobile phone, by which a first part of the mobile phone with a display can be pivoted about a horizontal axis of the hinge for opening/shutting the mobile phone, and about an upright axis of the hinge for changing a visual angle of the display.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a folding mobile phone assembled with a dual-directional hinge in accordance with the present invention;

FIG. 2 is an exploded perspective view of the dual-directional hinge in accordance with the present invention;

FIG. 3 is a front cross sectional view of the dual-directional hinge of the present invention;

FIG. 4 is a side cross sectional view of the dual-directional hinge of the present invention;

FIG. 5 is a perspective view of the dual-directional hinge of the present invention;

FIG. 6 is a schematic view of the folding mobile phone assembled with the hinge of the invention in an open position;

FIG. 7 is a front cross sectional view of the hinge in the status as shown in FIG. 6;

FIG. 8 is a side cross sectional view of the hinge in the status as shown in FIG. 6; and

FIG. 9 is a top schematic view of the hinge in FIG. 6.

### DETAILED DESCRIPTION OF THE PREFERRED EMBODIMENT

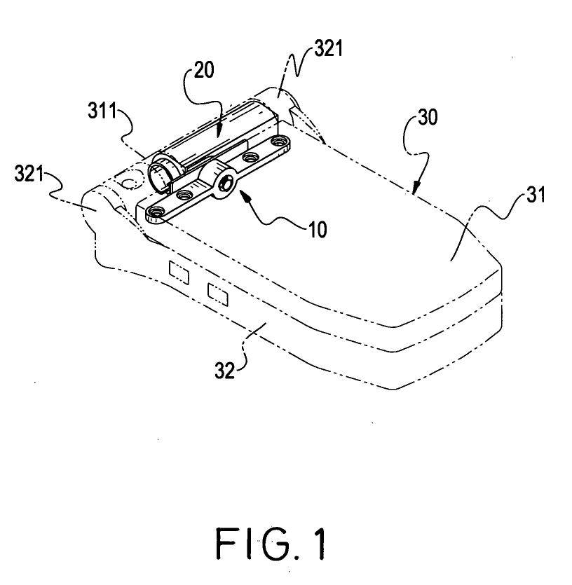

With reference to FIG. 1, a dual-directional hinge in accordance with the present invention is assembled between a first part (31) and a second part (32) of a mobile phone (30). The first part (31) includes a display (not shown), and the second part (32) includes a key pad and a lens (not shown) for a built-in digital camera (not shown). The first part (31) has a connected edge (311) with two ears (321) formed at two ends of the connected edge (311).

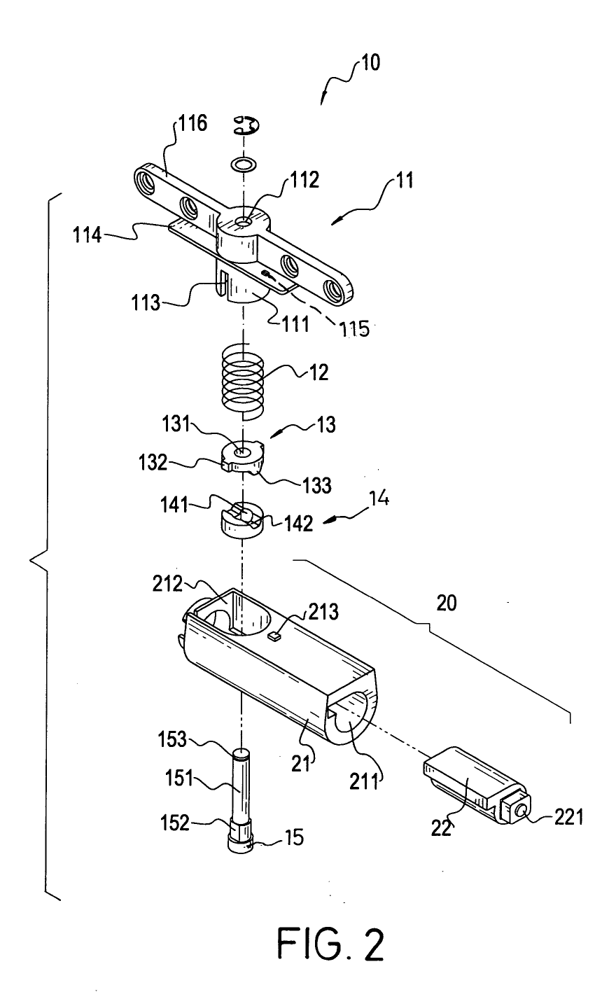

With reference to FIG. 2, the dual-directional hinge is composed of a first hinge member (20) and a second hinge member (10) perpendicularly linked to the first hinge member (20).

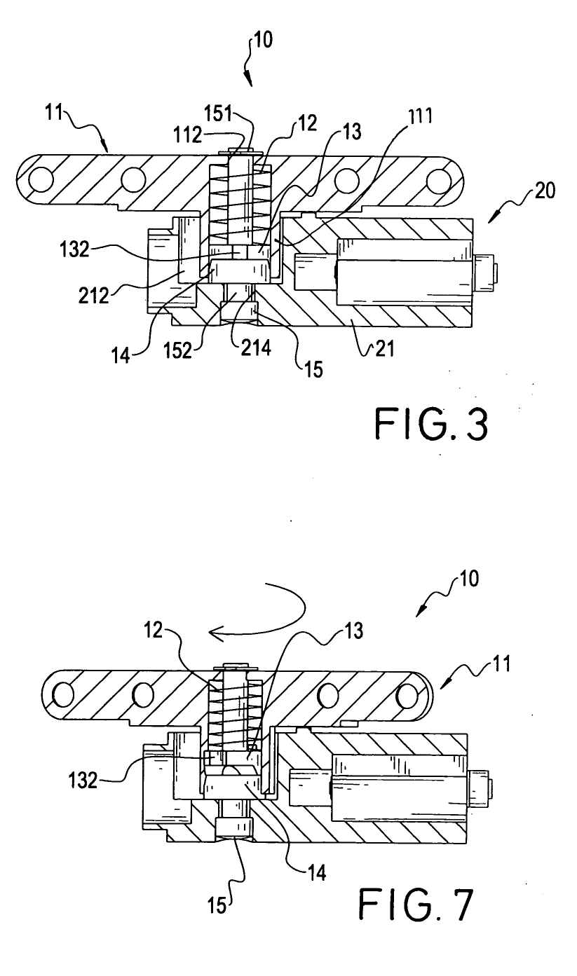

The first hinge member (20) has a first tubular part (21) provided mounted between the ears (321) of the first part (31). A passage (211) is longitudinally defined through a first end of the first tubular part (21), and a pintle (22) extends in the passage (211) of the tubular part (21). The pintle (22) has a pivot end (221) formed adjacent the first end of the first tubular part (21) and mounted in the corresponding ear (321) of the first part (31). An opening (212) is radially defined at a top side of the first tubular part (21) and adjacent the other end of the first tubular part (20). An aperture (214), coaxial with the opening (212), is defined at a bottom side of the first tubular part (20) and in communication with the opening (212), as shown in FIG. 3. The aperture (214) has an upper segment (not numbered) with a non-circular section. With reference back to FIG. 2, a protrusion (213) is formed beside the opening (212) at the top side of the first tubular part (20).

The second hinge member (10) is composed a pivot member (11), a resilient member (12), an upper disk (13), a lower disk (14), and a shaft (15). The pivot member (11) has a second tubular part (111) formed at a lower end thereof and rotatably received in the opening (212), and a first hole (112) defined at an upper end thereof. Two slots (113) are longitudinally defined at two diametrically opposite sides of an outer periphery of the second tubular part (111). Two wings (114) are symmetrically formed at two diametrically opposite sides of the second tubular part (111), and two arms (116) are symmetrically formed at the two diametrically opposite sides of the second tubular part (111) and respectively above the wings (114). Two lugs (115) are respectively and symmetrically formed at lower surfaces of the wings (114) and corresponding to the protrusion (213) of the first hinge member (20).

The resilient member (12) is received in the second tubular part (111) from the lower end of the pivot member (11). The upper disk (13) is received in the second tubular part (111) and under the resilient member (12). Two stops (132) are formed at two diametrically opposite sides of the resilient member (12) and respectively positioned in the slots (113) to fasten the upper disk (13) in the second tubular part (111). A second hole (131) is defined through the upper disk (13) and aligned with the first hole (112) of the pivot member (11). A ridge (133) is diametrically formed at a lower surface of the upper disk (13).

The lower disk (14) abuts the upper disk (13) and has a non-circular hole (141) defined therethrough and aligned with the first hole (112) and the second hole (131). A channel (142) is diametrically defined through an upper surface of the lower disk (14). Guide inclines are formed between the channel (142) and the upper surface for guiding the ridge (133) to position in the channel (142) when the upper disk (13) turns about the lower disk (14).

The shaft (15) extends through the aperture (214) and the opening (212) of the first hinge member (20) and through the lower disk (14) and the upper disk (13). A lower part (152) with a non-circular section of the shaft (15) is received in the upper segment of the aperture (214) to disable the shaft (15) to rotate in the first hinge member (20), and further received in the non-circular hole (141) to disable the lower part (14) to rotate about the shaft (15). An upper part (51) with a circular section of the shaft (15) is received in the second tubular part (111) and extends through the lower disk (14) and the upper disk (13), and a ring recess (153) is defined at a top end of the shaft (15). A collar (not numbered) is fastened in the ring recess (153) to fasten the shaft (15) in the pivot member (11).

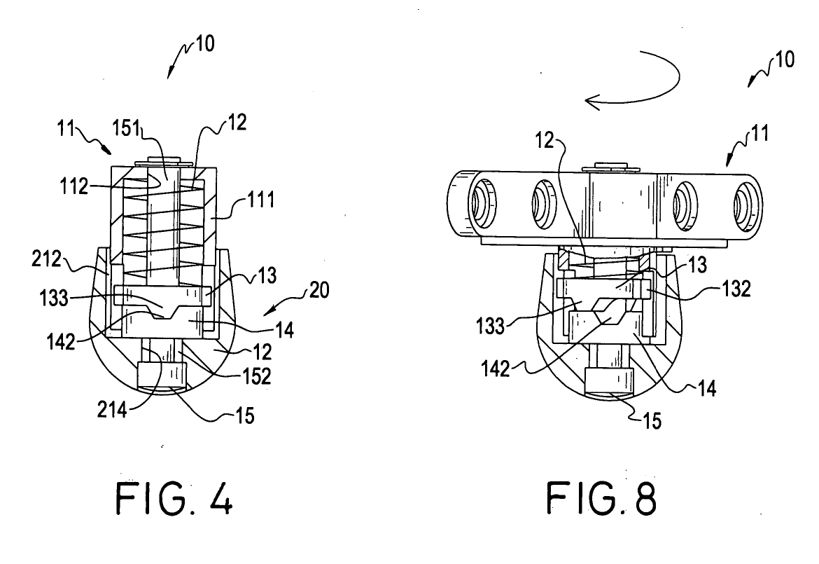

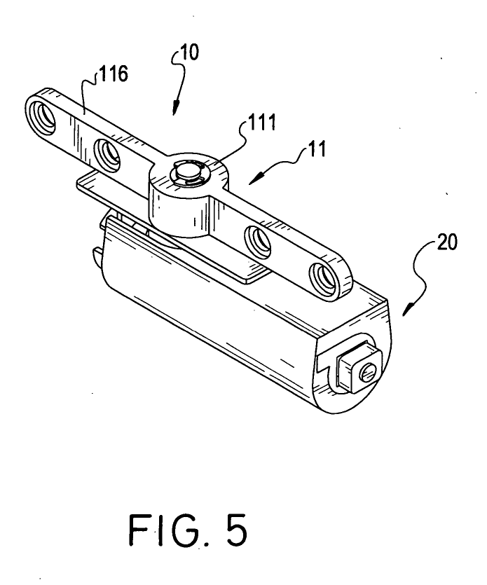

In assembly, with reference to FIGS. 3-5, the resilient member (12), the upper disk (13), and the lower disk (14) are in turn received in the second tubular part (111) from the lower end of the pivot member (11). The ridge (133) is positioned in the channel (142), and the stops (132) are located in the slots (113). Thereafter, the second tubular part (111) is inserted in the opening (212), and the shaft (15) extends in turn through the aperture (214), the non-circular hole (141), and the second hole (131), and out from the first hole (112). The lower part (152) is positioned in the upper segment of the aperture (214), and the non-circular hole (141) of the lower disk (14). The collar is fastened in the ring recess (153) to secure the shaft (15) in the first tubular part (21). Afterwards, the pintle (22) is inserted in the first tubular part (21). The assembled hinge is illustrated in FIG. 5.

In use, with reference back to FIG. 1, the first hinge member (20) is secured between the ears (321) of the second part (32), and the second hinge member (10) is secured on the first part (31).

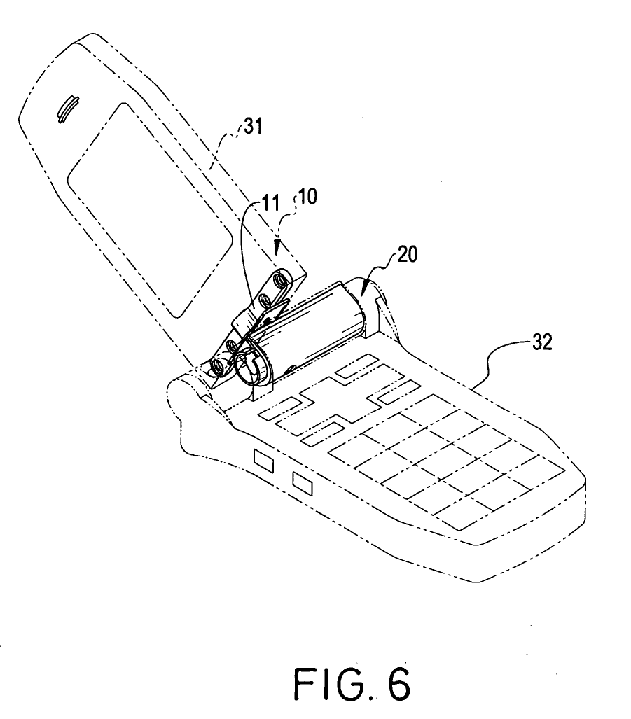

With reference to FIG. 6, a user can pivot upwards the first part (31) to open the mobile phone by turning the first hinge member (20) about the ears (321), and can turn leftwards the first part (31) about the second hinge member (10).

With reference to FIGS. 7 and 8, when the second hinge member (10) is turned, the second tubular part (111) is rotated about the shaft (15). In this case, the upper disk (13) is turned about the shaft (15) along with the second tubular part (111). Because the lower disk (14) is fixed in the first tubular part (21) and immovable about the shaft (15), the upper disk (13) is turned about the lower disk (14), and the ridge (133) is disengaged from the channel (142). After the lower disk (14) is turned 180°, under the force of the resilient member (12), the ridge (133) is guided by the inclines to position in the channel (142) again. Therefore, when the lens on the second part (32) faces an object to be photographed, the display of the first part (31) opposed to the lens can be seen by the user.

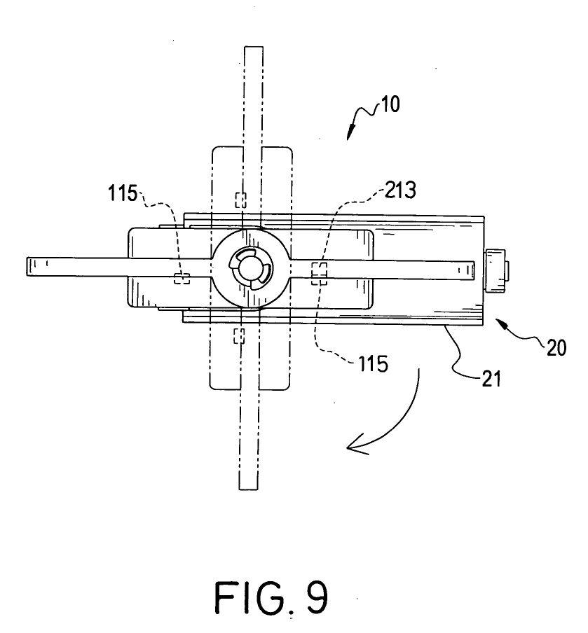

With reference to FIG. 9, when the first part (31) is in the original position, the first lug (115) abuts the protrusion (213) to prevent the first part (31) from turning reversedly; and when the first part (31) is turned 180°, the other lug (115) abuts the protrusion (213) to prevent the first part (31) from turning excessively.

Therefore, according the present invention, the first part (31) can be turned upwards/downwards to open/close the mobile phone, and can be turned leftwards/rightwards for reversing the display to face the user during taking photographs using the lens on the second part (32).

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A dual-directional hinge for a mobile phone comprising:
a first hinge member having a first tubular part, a passage longitudinally defined at a first end of the first tubular part, a pintle received in the passage, and an opening radially defined at a top side of the first tubular part and adjacent a second end of the first tubular part; and
a second hinge member perpendicular to the first hinge member and mounted in the opening of the first hinge member, the second hinge member having a second tubular part rotatably received in the opening, two arms respectively formed at two diametrically opposite sides of the second tubular part, a first hole defined through a top end of the second tubular part, a resilient member received in the second tubular part from a bottom end of the second tubular part, an upper disk securely received in the second tubular part and under the resilient member, the upper disk having a ridge formed at a bottom surface of the upper disk and a second hole defined through the upper disk, a lower disk beneath the upper disk having a channel defined at a top surface of the lower disk for positioning the ridge and guide inclines formed between the channel and the top surface, and a shaft securely extending through the first hinge member and the lower disk, and rotatably extending through the upper disk, the resilient member and the second tubular part.

2. The dual-directional hinge as claimed in claim 1, wherein the first hinge member further has an aperture with a non-circular segment defined beneath the opening and in communication with the opening; the lower disk has a non-circular hole defined through the lower disk; and the shaft has a lower part with a non-circular section matching the non-circular segment of the aperture and the non-circular hole of the lower disk.

3. The dual-directional hinge as claimed in claim 1, wherein the second tubular part has two slots longitudinally defined at the bottom end of the second tubular part; and the upper disk has two stops formed at two diametrically opposite sides of the upper disk and respectively positioned in the slots.

4. The dual-directional hinge as claimed in claim 1, wherein the ridge is diametrically formed at the upper disk; and the channel is diametrically defined at the lower disk.

5. The dual-directional hinge as claimed in claim 1, wherein the shaft has a ring recess defined at a top end of the shaft extending out of from the first hole of the second tubular part; and a collar is fastened in the ring recess.

6. The dual-directional hinge as claimed in claim 1, wherein the first tubular part has a protrusion formed at the top side beside the opening; the pivot member has two wings formed at two diametrically opposite sides of the second tubular part; and two lugs are respectively and symmetrically formed at two bottom surfaces of the wings for abutting the protrusion.
